(19) United States
(12) Patent Application Publication
(10) Pub. No.: US 2014/0017946 A1
(43) Pub. Date: Jan. 16, 2014

(54) TERMINAL AND CONNECTOR USING SAME

(71) Applicants: Jiro Koyama, Shanghai (CN); Hirotada Teranishi, Osaka (JP)

(72) Inventors: Jiro Koyama, Shanghai (CN); Hirotada Teranishi, Osaka (JP)

(73) Assignee: OMRON CORPORATION, Kyoto-shi, Kyoto (JP)

(21) Appl. No.: 13/985,583

(22) PCT Filed: Mar. 24, 2011
(86) PCT No.: PCT/JP2011/057179

§ 371 Date: Sep. 24, 2013

(30) Foreign Application Priority Data
Mar. 14, 2011 (JP) 2011-055726

(51) Int. Cl. H01R 13/24

(52) U.S. Cl. CPC H01R 13/2428
USPC 439/625

(57) ABSTRACT

A terminal has a movable contact that projects movably into and out of a contact hole of a housing. At least one through-hole is provided behind a contact surface of the movable contact. The contact surface of the movable contact has an arc shape. Thickness of the movable contact is uniform.

### BACKGROUND

1. Technical Field

The present invention relates to a terminal, for example, capable of being not only incorporated in a housing to form a connector but also directly mounted on a side end surface of a substrate to be used.

2. Related Art

Conventionally, as a terminal, for example, there is a spring connector including a conductive pin arranged slidably in the projecting and retreating directions so as not to be slipped off in a conductive tube, and a coil spring compressed for elastically biasing the conductive pin in the projecting direction, wherein a winding outer diameter of at least one part of the coil spring is set to be smaller than or the same as a winding inner diameter of the other part which is next turn of winding, and the one part is capable of being accommodated inside the other part in a state in which the coil spring is compressed (refer to Patent Document 1).

As shown in FIG. 1 of Patent Document 1, in the spring connector 20 described above, the conductive pin 14 is biased in the axial direction by the coil spring 26. By pressure contact of the conductive pin 14 with an abutment terminal 46 of a battery 44 shown in FIG. 5 thereof, electrical connection is formed while ensuring predetermined contact pressure.
Patent Document 1: Japanese Unexamined Patent Publication No. 11-149954

### SUMMARY

Under a situation that a battery having a large capacity is used, a temperature of the spring connector described above easily becomes too high due to heat generation by contact resistance. Thus, electric current capacity allowing conducting is easily decreased.

With the spring connector, when impact force from the outside is applied, due to large inertia force of the conductive pin, there is a fear that the contact surface of the conductive pin is instantaneously brought away from the battery and an instantaneous interruption may be generated.

One or more embodiments of the present invention provides a terminal in which a temperature does not easily become too high even when heat is generated by contact resistance so as to prevent an instantaneous interruption, and a connector using the same.

According to one or more embodiments of the present invention, a terminal comprises a movable contact that projects movably into and out of a contact hole of a housing, wherein at least one through-hole is provided behind a contact surface of the movable contact.

According to one or more embodiments of the present invention, since an exposed area in the movable contact is increased and cooling efficiency is improved, a terminal can be obtained in which a temperature does not easily become too high.

When the cooling through-hole is provided in the movable contact, a mass of the movable contact itself is reduced. Therefore, even if impact force from the outside such as impact force due to dropping is applied to the housing, since inertia force of the movable contact is small, an instantaneous interruption which is an electric connection failure instantaneously generated by the inertia force of the movable contact can be prevented.

According to one or more embodiments of the present invention, the contact surface of the movable contact may have an arc shape or a linear shape.

According to one or more embodiments of the present invention, by making the contact surface different, the terminal can be selected according to the use, and a degree of freedom in design is increased.

According to one or more embodiments of the present invention, thickness of the movable contact may be uniform.

According to one or more embodiments of the present invention, stress concentration can be avoided and designing is easily performed.

According to one or more embodiments of the present invention, the movable contact may have a pin shape.

According to one or more embodiments of the present invention, the exposed area is increased by an inner circumferential surface of the cooling through-hole, and the cooling efficiency is increased. Thus, the pin-shaped terminal can be obtained in which the temperature does not easily become too high.

In a connector according to one or more embodiments of the present invention, the movable contact of the above-described terminal may project movably into and out of a contact hole provided in a housing.

According to one or more embodiments of the present invention, the exposed area of the movable contact is increased, and the cooling efficiency is increased. Thus, the connector can be obtained in which the temperature does not easily become too high.

When the cooling through-hole is provided in the movable contact, the mass of the movable contact itself is reduced. Therefore, there is an effect that the connector can be obtained in which, even if the impact force from the outside such as the impact force due to dropping is applied to the housing, since inertia force of the movable contact is small, the instantaneous interruption which is the electric connection failure instantaneously generated by the inertia force of the movable contact can be prevented.

### BRIEF DESCRIPTION OF THE DRAWINGS

FIGS. 1A and 1B are a perspective view and a plan view showing a connector to which terminals according to a first embodiment of the present invention are assembled.

FIG. 2 is an exploded perspective view of the connector to which the terminals according to the first embodiment shown in FIGS. 1A and 1B are assembled.

FIG. 3 is an exploded perspective view of the connector to which the terminals according to the first embodiment shown in FIGS. 1A and 1B are assembled, the connector seen from a different angle.

FIG. 4A is a perspective view showing a housing to which the terminals according to one or more embodiments of the present invention are assembled, and FIGS. 4B and 4C are sectional perspective views taken along line B-B and line C-C shown in FIG. 4A.

FIGS. 5A and 5B are front views of a fixing tool and the terminal shown in FIG. 2.

FIGS. 6A and 6B are sectional views showing states before and after an operation of the connector.

FIGS. 7A, 7B, and 7C are partial perspective views showing only movable contacts of terminals according to second, third, and fourth embodiments of the present invention.

### DETAILED DESCRIPTION

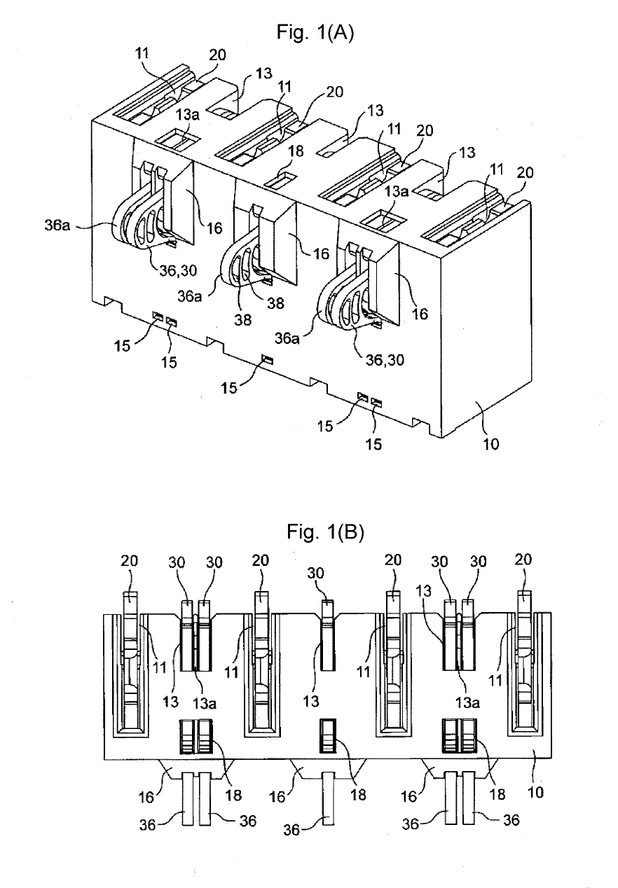

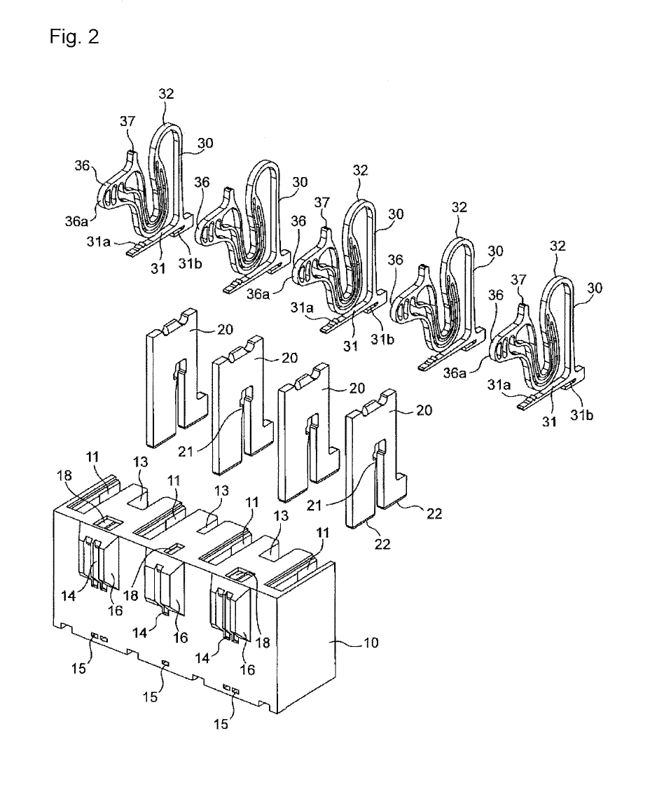

Embodiments of terminals according to the present invention will be described with reference to FIGS. 1A to 7C. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

As shown in FIGS. 1A to 6B, a first embodiment is a case of a connector in which fixing tools 20 are press-fitted at a predetermined pitch to a resin-molded housing 10 having a height of 4 mm, and connection terminals 30 are press-fitted between the fixing tools 20, 20.

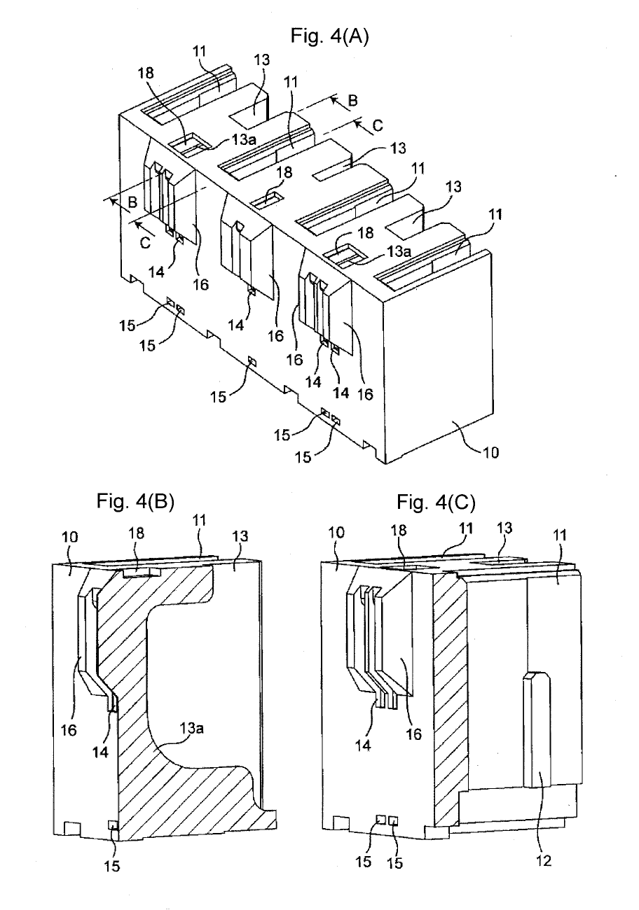

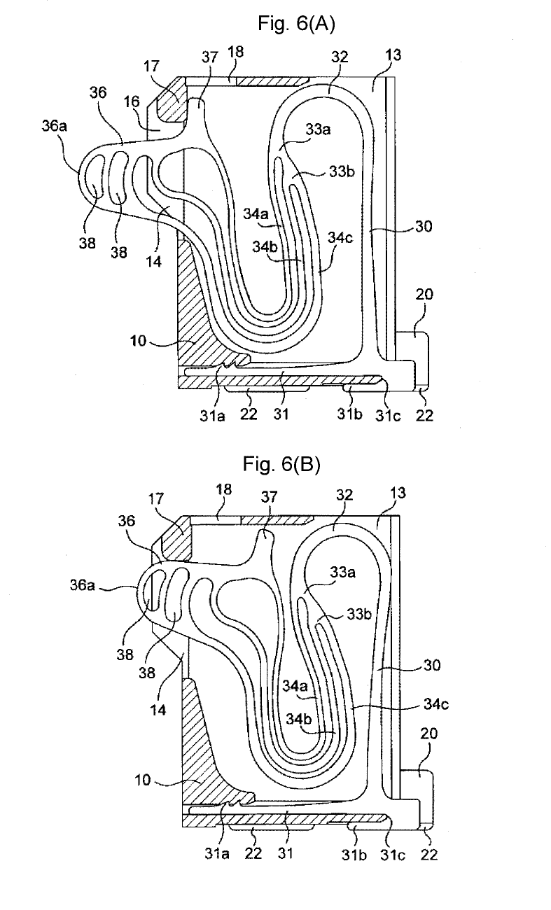

As shown in FIGS. 4A to 4C, in the housing 10, first housing spaces 11 into which the fixing tools 20 can be press-fitted from the upper side are provided at a predetermined pitch, and locking projections 12 are provided on facing inner surfaces of the first housing spaces 11. In the housing 10, three second housing spaces 13 into which the connection terminals 30 can be press-fitted from the rear surface side are arranged side by side between the first housing spaces 11, 11. In particular, the second housing spaces 13 provided in both ends are partitioned by partition walls 13a. Further, on the front surface side of the housing 10, contact holes 14 communicating with the second housing spaces 13 are provided, the contact holes into and out of which below-described movable contacts 36 can be moved, and press-fitting holes 15 communicating with the second housing spaces 13 are provided. Reinforcing ribs 16 are arranged in a projecting manner in both side opening edges of the contact holes 14, and position regulating receiving portions 17 (FIGS. 6A and 6B) are formed in upper edges of the contact holes 14. In front surface side edges of an upper surface of the housing 10, inspection holes 18 communicating with the second housing spaces 13 are provided.

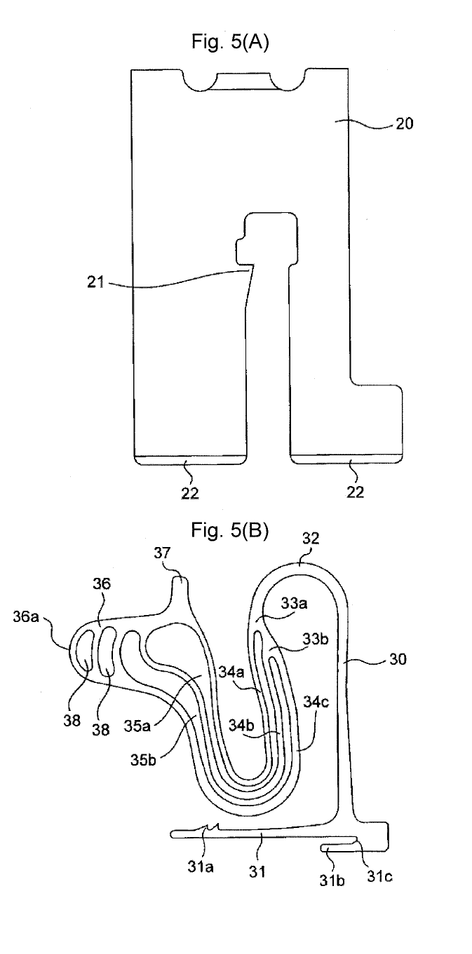

As shown in FIG. 5A, the fixing tool 20 is a substantially gate-shaped press-molded product formed by punching out a metal thin plate by press working, and a locking claw 21 is arranged in a projecting manner on an inner surface thereof. Therefore, when the fixing tool 20 is press-fitted into the first housing space 11 of the housing 10 from the upper side, the locking claw 21 is locked onto the locking projection 12 of the housing 10, so that the fixing tool 20 is retained, and fixing lower ends 22 of the fixing tool 20 are exposed from a bottom surface of the housing 10 so as to be connected and fixed (FIGS. 6A and 6B).

As shown in FIG. 5B, in the connection terminal 30, a substantially J-shaped support portion 32 projects upward from a press-fitting fixing portion 31, a first extending portion 34a and a second branch portion 33b extend from a first branch portion 33a positioned in a distal end of the support portion 32, and second and third extending portions 34b, 34c branch off from the second branch portion 33b.

While a locking claw 31a is arranged in a projecting manner on an upper surface of one end of the press-fitting fixing portion 31, by providing a connection portion 31b from a lower surface of the other end thereof, a press-fitting cutout portion 31c is formed.

The first, second, and third extending portions 34a, 34b, 34c branching off from the first branch portion 33a and the second branch portion 33b extend so as to meander substantially in parallel, so that first and second slits 35a, 35b are formed. Therefore, stress concentration on the branch portions 33a, 33b is not easily generated, and there are advantages that the life is long and a degree of freedom in design is increased.

Further, the movable contact 36 is provided in a free end formed by integrating distal ends of the first, second, and third extending portions 34a, 34b, 34c, and a position regulating projecting portion 37 is arranged in a projecting manner in the distal end of the first extending portion 34a. In the movable contact 36, a plurality of cooling through-holes 38 passing through in the direction parallel to a contact surface 36a are arranged side by side behind the contact surface 36a.

In the present embodiment, width in curved parts of the first, second, and third extending portions 34a, 34b, 34c is gradually increased. Therefore, there are advantages that the stress concentration at the time of an operation is not easily generated and the life is extended.

The width of the first and second slits 35a, 35b according to the present embodiment is set in such a manner that even when the movable contact 36 of the connection terminal 30 is operated, the first, second, and third extending portions 34a, 34b, 34c are not brought into contact with each other. Therefore, the first, second, and third extending portions 34a, 34b, 34c are not brought into contact with each other at the time of a predetermined operation, and an unpleasant contact sound is not generated.

Further, since the plurality of cooling through-holes 38 are provided in the movable contacts 36 and an exposed area is increased, even when the movable contacts 36 generate heat based on the contact resistance, there are advantages that the cooling can be efficiently performed and a temperature does not easily become too high.

Next, when the plurality of cooling through-holes 38 are provided in the movable contacts 36, inertia force of the movable contacts 36 is reduced. Thus, even if impact force from the outside is applied, there are advantages that an instantaneous interruption is not easily generated and contact reliability is improved.

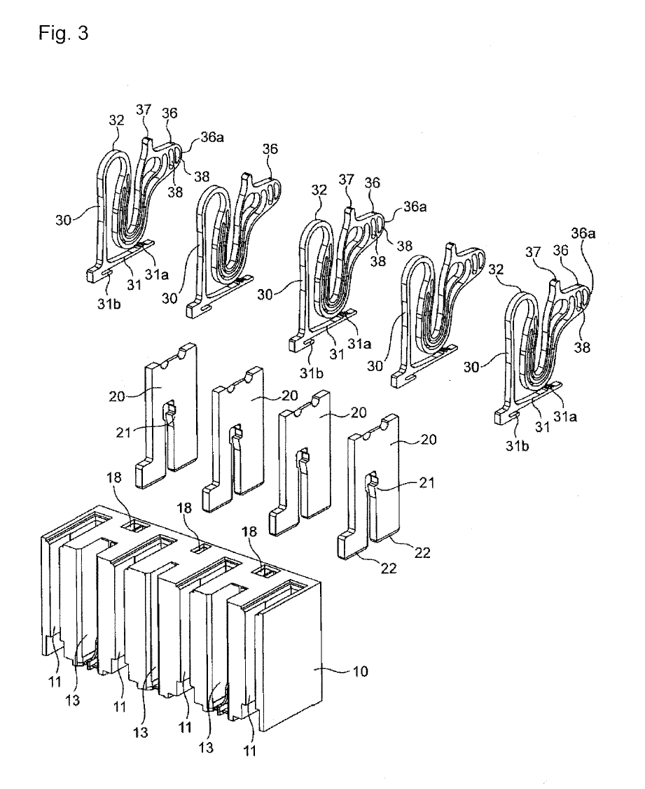

As shown in FIG. 3, the connection terminals 30 are inserted into the second housing spaces 13 of the housing 10 from the rear surface side. The press-fitting fixing portions 31 are press-fitted into the press-fitting holes 15, the locking claws 31a are locked onto inner surfaces of the press-fitting holes 15, and the cutout portions 31c are engaged with an edge of the housing 10, so that fixing can be performed. Thereby, the position regulating projecting portions 37 of the connection terminals 30 are abutted on the position regulating receiving portions 17 of the housing 10 so that a position is regulated, and the connection portions 31b of the connection terminals 30 become flush with the fixing lower ends 22 of the fixing tools 20.

Next, when the movable contacts 36 are pushed in by pressure contact of the connector in which a print substrate (not shown) is mounted with a battery of a mobile electronic device for example, the first, second, and third extending portions 34a, 34b, 34c are elastically deformed, and the support portions 32 are also elastically deformed. Within a predetermined range of a push-in amount, since the width of the first and second slits 35a, 35b is large, the first, second, and third extending portions 34a, 34b, 34c are not brought into contact with each other, so that a friction sound is not generated. In particular, since the meandering first, second, and third extending portions 34a, 34b, 34c and the support portions 32 are arranged between the movable contacts 36 and the press-fitting fixing portions 31, a spring length is long. Thus, a desired displacement amount can be ensured, and the stress concentration is not easily generated. Therefore, contact reliability is improved and the connector having the longer life can be obtained.

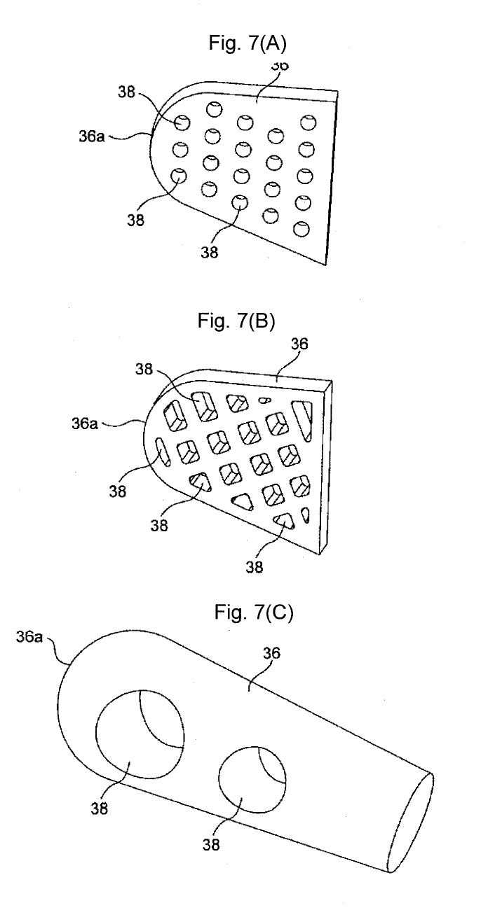

A second embodiment is a case where a large number of circular cooling through-holes 38 is provided in a grid form as shown in FIG. 7A, whereas the first embodiment described above is a case where two substantially-oval cooling through-holes 36 are arranged side by side in the movable contact 36. A third embodiment is a case where a large number of differently-shaped cooling through-holes is provided in a grid form as shown in FIG. 7B. Since other parts are the same as the first embodiment described above, description thereof will be omitted.

According to the present embodiments, there are advantages that the terminal can be obtained in which the exposed area in the movable contacts 36 is increased and cooling efficiency is further increased.

A fourth embodiment is a case where two cooling through-holes 38 are provided behind a contact surface 36a of a pin-shaped movable contact 36 as shown in FIG. 7C.

According to the present embodiment, also, the terminal can be obtained in which the exposed area of the movable contacts 36 is increased, the cooling efficiency is further increased, and the temperature does not easily become too high.

According to the above embodiment, a mass of the movable contacts 36 is reduced and the inertia force is reduced. Thus, even if the impact force from the outside is applied, the instantaneous interruption which is an instantaneous electric connection failure can be prevented, and there is an advantage that the terminal having high contact reliability can be obtained.

Although a case is described where one pair of two connection terminals and an individual connection terminal are combined in order to enhance the contact reliability, only an individual connection terminal may be used for all, or one pair of two connection terminals may be used for all. Further, one pair of three connection terminals may be incorporated, and if necessary, the number of the connection terminals can be selected as a matter of course.

The extending portions and the slits are not required to have uniform width but the width may be changed if necessary. For example, by increasing only the width of the curved parts of the extending portions positioned on the outer side among the curved parts of the extending portions so as to prevent generation of the stress concentration, durability may be enhanced.

Further, although a case is described where the connection terminals are incorporated in the housing in the above embodiment, the print substrate itself may serve as the housing and the connection terminals of the present application may be directly incorporated in a side end surface thereof. Accordingly, there is an advantage that the conventional housing and the fixing tools are not required, and as a result, the entire device can be furthermore downsized.

The terminal according to one or more embodiments of the present invention is not particularly limited to the above shapes as long as the terminal has cooling through-holes in movable contacts.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF SYMBOLS

10: Housing
13: Second housing space
14: Contact hole
17: Position regulating receiving portion
20: Fixing tool
30: Connection terminal
31: Press-fitting fixing portion
32: Support portion
33a, 33b: First branch portion, second branch portion
34a, 34b, 34c: First, second, third extending portion
35a, 35b: First, second slit
36: Movable contact
36a: Contact surface
37: Position regulating projecting portion
38: Cooling through-hole

1. A terminal comprising:
a movable contact that projects movably into and out of a contact hole of a housing,
wherein at least one through-hole is provided behind a contact surface of the movable contact.

2. The terminal according to claim 1, wherein the contact surface of the movable contact has an arc shape.

3. The terminal according to claim 1, wherein the contact surface of the movable contact has a linear shape.

4. The terminal according to claim 1, wherein thickness of the movable contact is uniform.

5. The terminal according to claim 1, wherein the movable contact has a pin shape.

6. A connector comprising:
the terminal according to claim 1; and
the housing comprising the contact hole,
wherein the movable contact of the terminal projects movably into and out of the contact hole provided in the housing.

7. The terminal according to claim 2, wherein thickness of the movable contact is uniform.

8. The terminal according to claim 3, wherein thickness of the movable contact is uniform.

9. The terminal according to claim 2, wherein the movable contact has a pin shape.

10. The terminal according to claim 3, wherein the movable contact has a pin shape.

11. The terminal according to claim 4, wherein the movable contact has a pin shape.

12. The terminal according to claim 7, wherein the movable contact has a pin shape.

13. The terminal according to claim 8, wherein the movable contact has a pin shape.

14. A connector comprising:
the terminal according to claim 2; and
the housing comprising the contact hole,
wherein the movable contact of the terminal projects movably into and out of the contact hole provided in the housing.

15. A connector comprising:
the terminal according to claim 3; and
the housing comprising the contact hole,
wherein the movable contact of the terminal projects movably into and out of the contact hole provided in the housing.

16. A connector comprising:
the terminal according to claims 4; and
the housing comprising the contact hole,
wherein the movable contact of the terminal projects movably into and out of the contact hole provided in the housing.

17. A connector comprising:
the terminal according to claim 5; and
the housing comprising the contact hole,
wherein the movable contact of the terminal projects movably into and out of the contact hole provided in the housing.

18. A connector comprising:
the terminal according to claim 6; and
the housing comprising the contact hole,
wherein the movable contact of the terminal projects movably into and out of the contact hole provided in the housing.

19. The terminal according to claim 1, wherein the movable contact projects movably into and out of the contact hole in a direction parallel to the contact surface.

20. The connector of claim 6, wherein the movable contact projects movably into and out of the contact hole in a direction parallel to the contact surface.
